(19) United States
(12) Patent Application Publication
(10) Pub. No.: US 2007/0262015 A1
(43) Pub. Date: Nov. 15, 2007

(54) Filter

(75) Inventors: Rebecca Lotzsch, Minden (DE); Florian Rohde, Minden (DE)

Correspondence Address: VENABLE LLP, P.O. BOX 34385, WASHINGTON, DC, 20043-9998, US

(73) Assignee: Melitta Haushaltsprodukte GmbH & Co. KG, Minden (DE)

(21) Appl. No.: 11/797,990

(22) Filed: May 9, 2007

(30) Foreign Application Priority Data
May 11, 2006 (DE) 20 2006 007 829.0

(51) Int. Cl. B01D 39/14

(52) U.S. Cl. 210/473; 210/496

(57) ABSTRACT

A filter comprises first and second adjacent filter material layers. The first filter material layer is joined to the second material layer along only a partial circumferential section of the second filter material layer to form an essentially disk shaped receptacle for holding coffee or tea. The second filter material layer includes a pocket. A section of the first filter material layer not joined to the second filter material layer presents a foldable tongue that is insertable into the pocket.

### CROSS-REFERENCE TO RELATED APPLICATION

This application claims the priority of German Patent Application No: 20 2006 007 829.0, filed on May 11, 2006, the subject matter of which is incorporated herein by reference.

### BACKGROUND OF THE INVENTION

The present invention relates to a filter having a filter body that is composed of at least two layers of filtering material and comprising an essentially disk-shaped receptacle for filling in ground coffee or tea.

German Patent Application 20 2005 005474 discloses a filter bag for brewing material, which bag is provided with an essentially disk-shaped receptacle for holding ground coffee. A filling funnel that can be folded over for the closing adjoins this receptacle. The disadvantage of this known filter is that filling in the material through the projecting funnel is comparatively involved and that furthermore only a small filling opening is provided. To be sure, the filling opening can be closed off easily by simply folding over the projecting filling funnel. However, ground coffee may already spill during the filling operation, which negatively influences the acceptance of the filter.

### SUMMARY OF THE INVENTION

It is therefore an object of the present invention to provide a filter, used for brewing a beverage, which has a simple design and is easy to handle.

The above and other objects are accomplished according to the invention wherein there is provided, in one embodiment, a filter, comprising: first and second adjacent filter material layers, the first filter material layer being joined to the second material layer along only a partial circumferential section of the second filter material layer to form an essentially disk shaped receptacle for holding coffee or tea, wherein the second filter material layer includes a pocket, and a section of the first filter material layer not joined to the second filter material layer presents a foldable tongue that is insertable into the pocket.

The foldable tongue thus permits a comparably large filling opening to be formed between the first filter material layer and the second filter material layer, which can be closed easily by inserting the tongue into the pocket. It is not necessary to achieve a 100% seal in this case, but to ensure that no coffee grounds can escape to the outside during the subsequent brewing operation. This can be achieved by loosely inserting the tongue into the pocket.

According to one embodiment of the invention, the pocket has approximately the same dimensions as the foldable tongue. As a result, the filters can be stacked easily inside a box, wherein a disk-shaped flat form requires little storage space. The filling operation only requires the tongue to be folded upward to provide access to the receptacle.

For a simple production of the filter, the tongue is formed using a filter material section which is joined along the circumference with the second filter material layer. The pocket can be embodied so that a folding edge of the tongue is arranged adjacent to the opening edge of the pocket, thereby making it possible for the tongue to be completely inserted into the pocket. The opening edge in this case can be embodied as a straight line, so that when filling the ground coffee into the receptacle, the tongue can be secured with a clamping hold inside the pocket.

The filter may be made of paper which can be joined along the circumference with an embossed edge to connect the filter material layers, thereby resulting in a cost- effective production. It is also possible to use a different type of filtering material, for example a non- woven material.

### BRIEF DESCRIPTION OF THE DRAWINGS

These and other features and advantages of the invention will be further understood from the following detailed description, considered in conjunction with the accompanying drawings.

FIG. 1 is a top view of a filter according to the invention.

FIG. 2 is a side sectional view of the filter according to FIG. 1.

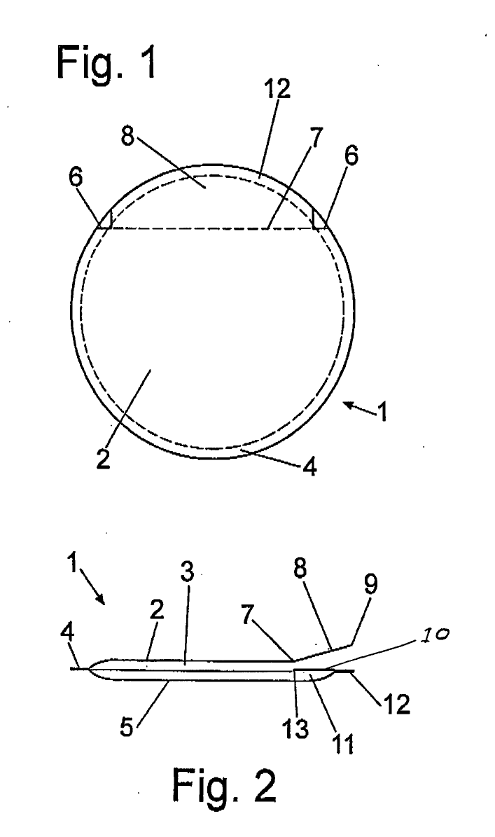

### DETAILED DESCRIPTION OF THE PREFERRED EMBODIMENTS

Referring to the drawings, a filter 1 comprises a disk-shaped filter material layer 2, which is arranged adjacent to a disk-shaped second filter material layer 5.

The filter material layers 2 and 5 are joined along the circumference with an embossed seam 4. This embossed seam 4 does not extend along the complete circumference, but only along a partial section thereof, up to the ends 6 of the embossed seam. The ends 6 of the embossed seam are arranged such that approximately 10% to 40%, preferably 20% to 30%, of the complete circumference is not provided with an embossed seam. In other words, the embossed seam 4 covers slightly more than half the circumference of the disk-shaped filter material layers 2 and 5.

A disk-shaped receptacle 3 is formed between the filter material layers 2 and 5, which can be filled with tea or ground coffee. For this, the filter material layer 2 is provided with a foldable tongue 8 that can be folded up in the region where the filter material layers 2 and 5 are not joined, so that a filling opening is formed between the filter material layers 2 and 5. Once the ground coffee or tea is filled in, the filter 1 can be closed by inserting the foldable tongue into a pocket 11.

The pocket 11 is formed by connecting a filter material section 10 along the circumferential edges with an embossed seam 12 to the filter material layer 5, approximately up to the ends 6. An opening edge 13 of the pocket 11 consequently extends adjacent to a folding edge 7 of the tongue 8 when the tongue is folded upward in the opened state.

Once the ground coffee or tea is filled in, the filter 1 can be closed again by inserting the tongue 8 into the pocket 11, wherein an edge 9 of the tongue 8 rests against the inside of the pocket 11.

As seen from above, the filter 1 is embodied disk shaped since the edge of the tongue 8 conforms to the edge of the lower filter material layer 5.

For the illustrated embodiment, the filter 1 with the filter material layers 2 and 5 consists of paper.

However, different fluid-permeable materials such as a non-woven or a multi-layer filtering material can also be used. The paper layers, however, can be joined easily with embossed seams along the edges.

For the illustrated embodiment, the dimensions for the tongue 8 are approximately the same as for the pocket 11, thus making it easy to secure the tongue 8. Of course, it is also possible to embody the pocket 11 slightly larger than the tongue 8 to permit a more loose insertion.

It will be understood that the above description of the present invention is susceptible to various modifications, changes and apaptations, and the same are intended to be comprehended within the meaning and range of equivalents of the appended claims.

What is claimed is:

1. A filter, comprising:
first and second adjacent filter material layers, the first filter material layer being joined to the second material layer along only a partial circumferential section of the second filter material layer to form an essentially disk shaped receptacle for holding coffee or tea, wherein the second filter material layer includes a pocket, and a section of the first filter material layer not joined to the second filter material layer presents a foldable tongue that is insertable into the pocket.

2. The filter according to claim 1, wherein the pocket has dimensions that are approximately the same as those for the foldable tongue.

3. The filter according to claim 1, further including a filter material section connected to the second filter material layer along the circumference of the second filter material layer to form the pocket.

4. The filter according to claim 1, wherein the tongue has a folding edge arranged adjacent to an opening edge of the pocket.

5. The filter according to claim 1. wherein the first and second filter material layers are comprised of paper and are joined with an embossed seam.
